(19) United States
(12) Patent Application Publication
(10) Pub. No.: US 2023/0370269 A1
(43) Pub. Date: Nov. 16, 2023

(54) DISTRIBUTED LEDGER PLATFORM FOR ELECTRONIC VOTING AND/OR POLLING

(71) Applicant: University of Florida Research Foundation, Incorporated, Gainesville, FL (US)

(72) Inventors: My T. Thai, Gainesville, FL (US); Truc Nguyen, Gainesville, FL (US)

(21) Appl. No.: 18/316,064

(22) Filed: May 11, 2023

Related U.S. Application Data
(60) Provisional application No. 63/341,224, filed on May 12, 2022.

(51) Int. Cl. H04L 9/32; G07C 13/00; G06F 16/27; H04L 9/00

(52) U.S. Cl. CPC H04L 9/3218; G07C 13/00; G06F 16/27; H04L 9/008

(57) ABSTRACT

Various embodiments of the present disclosure provide a distributed ledger platform for electronic voting and/or polling. In one example, an embodiment provides for receiving a request to commit a transaction to a distributed ledger in the distributed ledger system. The transaction may include one or more encrypted votes, a cryptography authentication proof, and/or an input validation proof. Another embodiment provides for executing a smart contract to (i) authenticate a user identifier associated with the transaction based on the cryptography authentication proof and (ii) validate the one or more encrypted votes based on the input validation proof. In an instance in which the smart contract authenticates the user identifier and validates the one or more encrypted votes, a data block associated with the transaction is added to the distributed ledger.

### CROSS-REFERENCE TO RELATED APPLICATIONS

This application claims the benefit of U.S. Provisional Patent Application No. 63/341,224, titled “DISTRIBUTED LEDGER PLATFORM FOR ELECTRONIC VOTING AND/OR POLLING,” and filed on May 12, 2022, which is incorporated herein by reference in its entirety.

### TECHNICAL FIELD

The present application relates to the technical field of distributed ledger and/or encryption technologies. In particular, the invention relates to employing distributed ledger and/or encryption technologies for electronic voting systems and/or electronic polling systems.

### BACKGROUND

Despite recent technical advancements, current electronic voting systems do not adequately address technical challenges for electronic voting systems such as, for example, security and/or privacy. For instance, security and/or privacy challenges related to current electronic voting systems are generally due to lack of transparency in the electronic voting process and/or inadequate privacy guarantee for voters.

### SUMMARY

In general, embodiments of the present invention provide methods, apparatus, systems, computing devices, computing entities, and/or the like for detecting audio deepfakes through acoustic prosodic modeling. The details of some embodiments of the subject matter described in this specification are set forth in the accompanying drawings and the description below. Other features, aspects, and advantages of the subject matter will become apparent from the description, the drawings, and the claims.

In an embodiment, a method for execution in a distributed ledger system is provided. The method provides for receiving, by a node computing entity in the distributed ledger system, a request to commit a transaction to a distributed ledger in the distributed ledger system. In one or more embodiments, the transaction comprises one or more encrypted votes, a cryptography authentication proof, and/or an input validation proof. The method additionally or alternatively provides for executing, by the node computing entity in the distributed ledger system, a smart contract to (i) authenticate a user identifier associated with the transaction based on the cryptography authentication proof and (ii) validate the one or more encrypted votes based on the input validation proof. In an instance in which the smart contract authenticates the user identifier and validates the one or more encrypted votes, the method additionally or alternatively provides for adding a data block associated with the transaction to the distributed ledger.

In another embodiment, an apparatus is provided. The apparatus comprises at least one processor and at least one memory including program code. The at least one memory and the program code is configured to, with the at least one processor, cause the apparatus to receive, by a node computing entity in a distributed ledger system, a request to commit a transaction to a distributed ledger in the distributed ledger system. In one or more embodiments, the transaction comprises one or more encrypted votes, a cryptography authentication proof, and/or an input validation proof. In one or more embodiments, the at least one memory and the program code is configured to, with the at least one processor, cause the apparatus to execute, by the node computing entity in the distributed ledger system, a smart contract to (i) authenticate a user identifier associated with the transaction based on the cryptography authentication proof and (ii) validate the one or more encrypted votes based on the input validation proof. In an instance in which the smart contract authenticates the user identifier and validates the one or more encrypted votes, in one or more embodiments, the at least one memory and the program code is configured to, with the at least one processor, cause the apparatus to add a data block associated with the transaction to the distributed ledger.

In yet another embodiment, a non-transitory computer storage medium comprising instructions is provided. The instructions are configured to cause one or more processors to at least perform operations configured to receive, by a node computing entity in a distributed ledger system, a request to commit a transaction to a distributed ledger in the distributed ledger system. In one or more embodiments, the transaction comprises one or more encrypted votes, a cryptography authentication proof, and/or an input validation proof. In one or more embodiments, the instructions are configured to cause one or more processors to at least perform operations configured to execute, by the node computing entity in the distributed ledger system, a smart contract to (i) authenticate a user identifier associated with the transaction based on the cryptography authentication proof and (ii) validate the one or more encrypted votes based on the input validation proof. In an instance in which the smart contract authenticates the user identifier and validates the one or more encrypted votes, in one or more embodiments, the instructions are configured to cause one or more processors to at least perform operations configured to add a data block associated with the transaction to the distributed ledger.

### BRIEF DESCRIPTION OF THE DRAWINGS

Reference will now be made to the accompanying drawings, which are not necessarily drawn to scale, and wherein:

FIG. 1 illustrates a system associated with a setup phase for conducting setup of a distributed ledger platform, according to one or more embodiments of the present disclosure;

FIG. 2 illustrates a system associated with a phase for managing submission of votes to a distributed ledger platform, according to one or more embodiments of the present disclosure;

FIG. 3 illustrates a system associated with a phase for aggregating encrypted votes submitted to a distributed ledger platform, according to one or more embodiments of the present disclosure;

FIGS. 4A-C illustrates an example distributed ledger process for initializing an electronic voting system, according to one or more embodiments of the present disclosure;

FIGS. 5A-B illustrates an example distributed ledger process for submitting votes for an electronic voting system based on distributed ledger technology, according to one or more embodiments of the present disclosure;

FIGS. 6A-C illustrates an example distributed ledger process for aggregating votes for an electronic voting system based on distributed ledger technology, according to one or more embodiments of the present disclosure;

FIG. 7 illustrates a graph related to encryption of a ballot question, according to one or more embodiments of the present disclosure;

FIG. 8A is an exemplary diagram of a system that can be used to practice one or more embodiments of the present disclosure;

FIG. 8B is an exemplary diagram of another system that can be used to practice one or more embodiments of the present disclosure;

FIG. 9 is an exemplary schematic of a node computing entity in accordance with one or more embodiments of the present disclosure;

FIG. 10 is an exemplary schematic of another node computing entity in accordance with one or more embodiments of the present disclosure; and

FIG. 11 is a flowchart of a method for execution in a distributed ledger system according to one or more embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Electronic voting systems such as, for example, remote electronic voting systems, enable voters to employ remote devices to submit a vote electronically to election authorities via the Internet. However, despite recent technical advancements, current electronic voting systems do not adequately address technical challenges for electronic voting systems such as, for example, security and/or privacy. For instance, security and/or privacy challenges related to current electronic voting systems are generally due to lack of transparency in the electronic voting process and/or inadequate privacy guarantee for voters. With the security and/or privacy challenges for current electronic voting systems, accuracy of voters' current electronic voting systems is jeopardized such that voters have no way of assuring that their votes were counted or whether their ballots were altered.

Additionally, current electronic voting systems generally do not provide adequate privacy protection for voters. For example, with current electronic voting systems, sensitive information for a voter may be accessed by an adversary (e.g., an untrusted entity) via a privacy breach. A privacy breach is often defined as the ability of an adversary to either reidentify or assert membership of any individual in a supposedly anonymized dataset. In the context of electronic voting, a privacy measure is desirable to prevent adversaries from determining whether a specific voter has voted or not. Current electronic voting systems fail to guarantee such membership privacy and are therefore vulnerable to a privacy breach. Additionally, current electronic voting systems generally require voters to authenticate themselves to confirm eligibility, which has the potential to further compromise membership privacy of a voter.

To address these and/or other issues, various embodiments described herein relate to a distributed ledger platform for electronic voting and/or polling. In various embodiments, the distributed ledger platform can be a blockchain-based platform for electronic voting and/or polling. With the distributed ledger platform, voting transactions can be maintained by a set of nodes. In various embodiments, one or more smart contracts can be employed to enable decentralized voting and/or polling. The distributed ledger platform can also provide a transparent electronic voting and/or polling process. In various embodiments, a voter can cast a vote as a blockchain transaction that can be stored in a smart contract. In various embodiments, a voting result can be verifiable by the public (e.g., due to openness and immutability of a blockchain for the distributed ledger platform), thereby eliminating a central trusted party (e.g., election authorities). Additionally, in various embodiments, homomorphic encryptions and/or zero-knowledge proofs can be employed to further protect privacy of voters (e.g., in terms of anonymity and/or membership privacy) while also providing improved accuracy and/or verifiability of votes.

In various embodiments, membership privacy for voters can also be provided. In various embodiments, the distributed ledger platform can employ one or more cryptographic techniques to provide a lightweight and/or secure protocol for voters. In various embodiments, each vote can be encrypted with threshold homomorphic encryption to, for example, conceal each individual vote while also ensuring that the respective votes can be aggregated to calculate a final voting result. Additionally or alternatively, in various embodiments, one or more non-interactive, zero-knowledge proof protocols can be employed to validate eligibility of voters and/or votes. For example, non-interactive zero-knowledge proofs can be submitted by a voter to a blockchain for the distributed ledger platform to, for example, conceal an identity of the voter. As a result, the distributed ledger platform enables a transparent and secure electronic voting system in which voters remain anonymous and each individual vote is hidden, while also providing a final voting result that can be verified by the public. As such, an electronic voting system and/or an electronic polling system with improved security and/or privacy can be provided. In various embodiments, data associated with electronic voting and/or polling can be stored in a decentralized manner to provide improved traceability, security, and/or quality of the data. Additionally, efficiency and performance of a user device and/or a network for electronic voting and/or polling can be improved.

### Exemplary Distributed Ledger Systems for Electronic Voting and/or Electronic Polling

According to various embodiments, a distributed ledger platform for electronic voting and/or electronic polling comprises one or more phases such as, for example, a setup phase and one or more other phases.

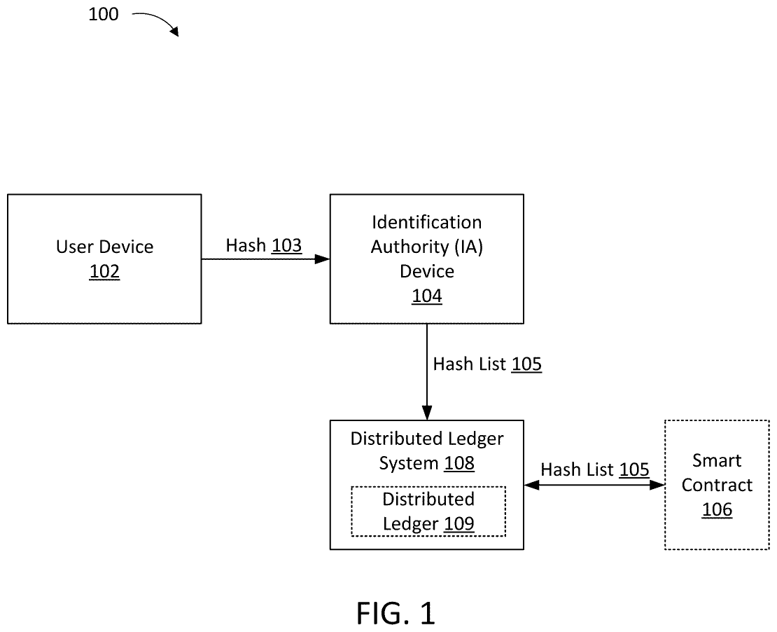

FIG. 1 illustrates a system 100 associated with a setup phase for conducting setup of a distributed ledger platform according to one or more embodiments of the present disclosure. The system 100 can be a distributed ledger platform for electronic voting and/or electronic polling. In various embodiments, the system 100 provides user registration (e.g., voter registration) for electronic voting and/or electronic polling.

The system 100 includes a user device 102, an identification authority (IA) device 104, a smart contract 106, and/or a distributed ledger system 108. The user device 102 can be a computing device such as, for example, an electronic voting device (e.g., a voting station computer), an electronic polling device (e.g., a polling station computer), a remote computing device, a mobile computing device, a smartphone, a tablet computer, a mobile computer, a desktop computer, a laptop computer, a wearable device, a virtual reality device, or another type of user device. In various embodiments, the user device 102 can be associated with a user identifier for a user that employs the user device 102. For example, the user device 102 can be associated with a voter identifier for a voter that employs the user device 102 to submit one or more votes for electronic voting and/or one or more entries for electronic polling. A vote can be, for example, one or more answerers to one or more ballot questions. The user identifier (e.g., the voter identifier) can be a unique identifier that can be kept secret by the user.

The IA device 104 can be a computing system (e.g., a server system, a host system, a cloud computing system, etc.) configured to manage identification of one or more user identifiers. In various embodiments, the user device 102 can register the user identifier (e.g., a unique identifier) with the IA device 104. For example, the user device 102 can generate a random number (e.g., a random l-bit number xᵢ where l is a value>>log N, where N corresponds to a number of users) that can be kept secret by the user device 102.

In various embodiments, the user device 102 can be communicatively coupled to the IA device 104 via one or more networks. For example, the user device 102 may communicate with the IA device 104 in whole or in part over one or more communication networks configured for wireless and/or wired network communication.

In various embodiments, the IA device 104 can be configured to maintain a hash (e.g., h(xᵢ)) of the user identifier for each user. A hash can be, for example, a cryptographic hash function of a user identifier. As such, in various embodiments, the user device 102 can register a hash 103 for the user identifier associated with the user device 102 with the IA device 104. The IA device 104 can maintain the hash 103 for the user identifier associated with the user device 102, as well as one or more other hashes for one or more other user identifiers associated with one or more other user devices. The hash 103 for the user identifier associated with the user device 102 can be, for example, a cryptographic hash function of the unique ID xᵢ. Accordingly, it is to be appreciated that the IA device 104 does not issue the user identifier associated with the user device 102. Therefore, privacy and anonymity of the user associated with the user device 102 can be provided as the IA device 104 is configured to store the hash 103 and not the random number and/or the user identifier. In various embodiments, if the hash 103 provided by the user device 102 already exists, the IA device 104 can request that the user device 102 generates a new random number and/or a new hash.

In various embodiments, the IA device 104 creates, maintains, and/or publishes a hash list 105 for the one or more user identifiers registered in the smart contract 106. For example, the hash list 105 can be a list H of the hashes (e.g., the cryptographic hash functions) for the one or more user identifiers registered in the smart contract 106. The smart contract 106 can be a public, self-executing, and/or self-enforcing program executed via the distributed ledger system 108. For example, the smart contract 106 can be executed via one or more node computing entities in the distributed ledger system 108. In some embodiments, a voting ballot can be implemented in the smart contract 106. In some embodiments, a voting ballot implemented in the smart contract 106 can comprise one or more questions (e.g., one or more ballot questions) to be answered by one or more user identifiers such as, for example, the user identifier associated with the user device 102. In some embodiments, a voting time period can be associated with the voting ballot implemented in the smart contract 106. In various embodiments, the distributed ledger system 108 can be configured as a blockchain system. Additionally, in various embodiments, the distributed ledger system 108 includes and/or is in communication with a distributed ledger 109. The distributed ledger 109 can be a database that is distributed and/or synchronized across multiple network nodes such as, for example, multiple node computing entities. In certain embodiments, the distributed ledger 109 can be a blockchain.

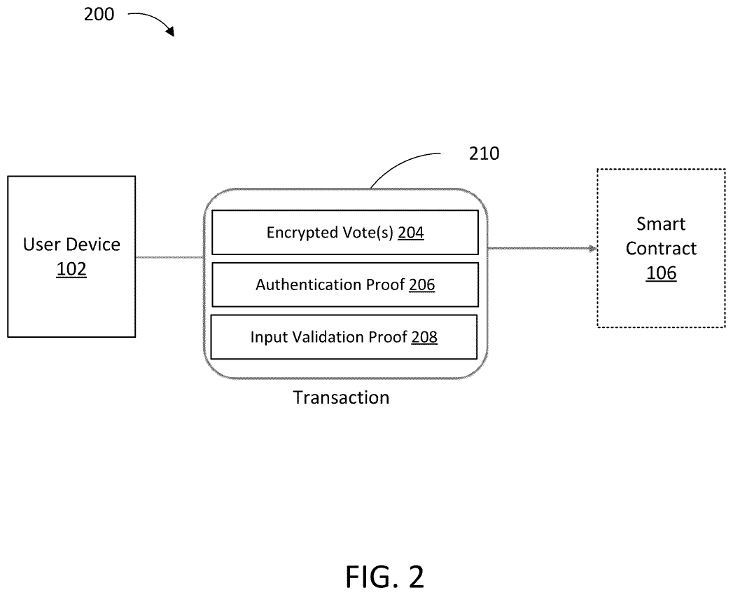

FIG. 2 illustrates a system 200 associated with a phase for managing submission of votes to a distributed ledger platform according to one or more embodiments of the present disclosure. The system 200 can be a distributed ledger platform for electronic voting and/or electronic polling. In various embodiments, one or more portions of the system 200 corresponds to the system 100. The system 200 includes the user device 102, the smart contract 106, and/or a transaction 210. In various embodiments, the smart contract 106 can be managed by and/or included in the distributed ledger system 108. The transaction 210 can be a transaction for the distributed ledger system 108. For example, in certain embodiments, the transaction 210 can be a blockchain transaction. The transaction 210 is configured to include encrypted votes 204, an authentication proof 206, and an input validation proof 208. In various embodiments, the transaction 210 can be processed by the smart contract 106 associated with the distributed ledger system 108.

The encrypted votes 204 can include one or more encrypted votes (Ri). The encrypted votes 204 can be one or more encrypted votes for a ballot implemented in the smart contract 106 that defines a list of questions and/or an aggregation algorithm that is employed for aggregating votes. In various embodiments, the encrypted votes 204 can be encrypted via homomorphic encryption. In one or more embodiments, the smart contract 106 can be public such that users can verify integrity of a ballot associated with the smart contract 106. The smart contract 106 can also be configured to allow users to verify the aggregation algorithm. In various embodiments, the smart contract 106 can define a voting period such that the smart contract 106 only accepts votes during the voting period. In various embodiments, a ballot can contain a list of questions Q={q₁, . . . , q|_{Q}|} where qⱼ is a ballot question with L possible options. The vote of a user Pᵢ can be denoted as Rᵢ, which can correspond to the encrypted answer to the questions in Q. In various embodiments, Paillier encryption can be applied to the list of questions Q to efficiently encrypt the answer to Q by using Paillier encryption only once while retaining homomorphism. For example, for each question qⱼ, denote qⱼₖ=1 if the user chooses the option k (k=1, . . . , L), otherwise qⱼₖ=0. Additionally, for each question qⱼ, vⱼ⁽ⁱ⁾=qⱼ₁·2⁰+qⱼ₂·2^{b}+ . . . q_{jL}·2^{b(L-1)} can be computed where b=┌log N┐. In various embodiments, vj can be a (bL)-bit number. In various embodiments, v_{Q}⁽ⁱ⁾=v1·2⁰+v₂·2^{bL}+ . . . +q|Q|·2^{bL(|Q|-1)} can be computed and a user can compute Rᵢ=Enc(pk, v_{Q}⁽ⁱ⁾) such that v_{Q}⁽ⁱ⁾ is encrypted using the key pk. In various embodiments, the Paillier encryption is additively homomorphic and/or semantically secure.

The authentication proof 206 can be one or more cryptography proofs and/or one or more cryptography protocols (πᵢ^{auth}) configured to provide proof of authentication (e.g., verify eligibility) of the user device 102 and/or the user identifier associated with the user device 102. In one or more embodiments, the authentication proof 206 can be a zero-knowledge authentication proof. In various embodiments, the IA device 104 illustrated in FIG. 1 can publish a hash and the user device 102 and/or the user identifier associated with the user device 102 can provide authentication to cast votes by producing the authentication proof 206. In certain embodiments, the authentication proof 206 can prove the statement: “user Pᵢ knows a secret number xᵢ such that h(xᵢ)∈H” where H is the public input and xᵢ is the secret witness. In various embodiments, the authentication proof 206 can be configured to not reveal any information about the unique ID xᵢ or the hash h(xᵢ).

In various embodiments, the authentication proof 206 can employ Zero-Knowledge Succinct Non-Interactive Argument of Knowledge (zk-SNARK) to prove authentication. For example, a zk-SNARK can be employed to construct a zero-knowledge authentication. In various embodiments, with a Merkle tree, a Merkle path can be employed to determine whether h(xᵢ) belongs to H. In various embodiments, a Merkle tree can be constructed from the set H and the user device 102 can employ zk-SNARK to generate a proof of membership showing that h(xᵢ) belongs to the Merkle tree. Specifically, denoting Hᵣ as the root of the Merkle tree with respect to H, the user device 102 can provide the Merkle path from h(xᵢ) to Hᵣ. Then, the user device 102 can employ zk-SNARK to generate a proof proving that the Merkle path is valid with respect to h(xᵢ) and Hᵣ. Without knowing xᵢ, an adversary cannot generate a valid authentication proof due to the second-preimage resistance of the hash function. Thus, by employing the authentication proof 206, eligibility verification can be achieved such that only users with a valid ID can submit a vote. In various embodiments, when generating the authentication proof 206, the user device 102 can compute a tag based on a public random bitstring that is defined in the smart contract 106. For example, the tag can be included in the authentication proof 206 and the smart contract 106 can be configured to accept one vote per tag.

The input validation proof 208 can be one or more data validation proofs and/or one or more data validation protocols (πᵢ^{inp}) that validate data (e.g., validate one or more votes) provided by the user device 102 and/or the user identifier associated with the user device 102. In one or more embodiments, the input validation proof 208 can be a zero-knowledge input validation proof. In various embodiments, the input validation proof 208 can be employed to prove that the encrypted votes 204 encrypted a valid value. In various embodiments, H can be realized using a cryptographic hash function. For example, H: {0, 1}*→{0, 1}^{λ} can represent a cryptographic hash function and/or a random oracle that outputs a random λ-bit value in response to each unique input query. In various embodiments, the input validation proof 208 can be employed by the user device 102 to inform the smart contract 106 that c encrypts a plaintext in V without revealing any other information, where V={m₁, . . . , m_{|V|}} corresponds to the set of valid values and c=Enc(mᵢ, r)=g^{mi}rⁿ mod n² can correspond to an encryption of mᵢ where i is secret. In various embodiments, the user device 102 can be configured to randomly pick a value w, |V|−1 values {eⱼ}_{1≤j≤|V|, j≠i}, and |V|−1 values {vⱼ}_{1≤j≤|V|, j≠i} from [symbol] *ₙ and compute uᵢ=wⁿ mod n² and uⱼ=vⱼⁿ (g^{mj}/c)^{ej} mod n² for j≠i. In various embodiments, the user device 102 can additionally be configured to compute e←H({uⱼ}_{1≤j≤|V|}, c, g, n, V) and/or compute eᵢ=e−Σ_{j≠i}eⱼ mod n and vᵢ=wr^{ei}, mod n. In various embodiments, the user device 102 can transmit the input validation proof 208 to the smart contract 106 via the transaction 210. For example, the user device 102 can send {vⱼ, eⱼ, uⱼ}_{1≤j≤|V|} to the smart contract 106.

In one or more embodiments, to submit a vote (e.g., a response to one or more questions on a voting ballot) using the user device 102, the user device 102 generates the transaction 210. For example, to submit a vote, each user device Pᵢ can issue a blockchain transaction to a smart contract containing a respective encrypted vote Rᵢ, a zero-knowledge proof associated with one or more cryptography protocols verifying their eligibility, and/or a zero-knowledge proof associated with one or more data validation protocols verifying validity of their vote. It is to be appreciated that neither the unique ID xᵢ nor the hash hᵢ is revealed when casting votes via the user device 102. The transaction 210 is then issued to the smart contract 106 executed via the distributed ledger system 108.

The smart contract 106 can validate the transaction 210 to determine whether to add one or more blocks of data to the distributed ledger 109 of the distributed ledger system 108. In one or more embodiments, the smart contract 106 can validate respective proofs and can record a vote in response to the respective proofs being valid. For example, the smart contract 106 can validate the authentication proof 206 and/or the input validation proof 208 included in the transaction 210 to determine whether to add a data block associated with the encrypted votes 204 to the distributed ledger 109 of the distributed ledger system 108. In an instance in which the smart contract 106 authenticates the user identifier and validates the encrypted votes 204, the authentication proof 206 and/or the input validation proof 208 included in the transaction 210, the data block associated with the transaction 210 can be added to the distributed ledger 109 of the distributed ledger system 108. In various embodiments, the smart contract 106 can be configured to accept one vote per proof. In various embodiments, to validate the input validation proof 208, the smart contract 106 can compute e←H({uⱼ}_{1≤j≤|V|}, c, g, n, V) and/or can check that e=Σⱼ eⱼ mod n and vⱼⁿ=uⱼ(c/g^{mj})^{ej} mod n² for all 1≤j≤|V|. In various embodiments, to achieve input independence such that a user cannot see other votes before submitting a vote, the user device 102 can submit the transaction 210 to the smart contract 106 during the voting period to provide a commitment of the encrypted votes 204. Additionally, at the end of the voting period, the user device 102 and/or the user identity associated with the user device 102 can reveal the encrypted votes 204 and the smart contract 106 can verify that the encrypted votes 204 matches the previously submitted commitment of the encrypted votes 204. In various embodiments, a commitment scheme can include an algorithm that takes as input a secret message and a random number, and outputs a commitment to the secret message. In various embodiments, a commitment can be configured to not reveal anything regarding the secret message. Additionally, a commitment can be computationally binding such that it is computationally infeasible to determine a secret message and/or random number associated therewith.

In various embodiment, after the smart contract 106 receives the encrypted votes 204, the smart contract 106 can aggregate encrypted voting results such that:

$${S}^{′} = {\prod }_{i = 1}^{N} {R}_{i} = Enc ( pk , {\sum }_{i} {v}_{Q}^{( i )} )$$

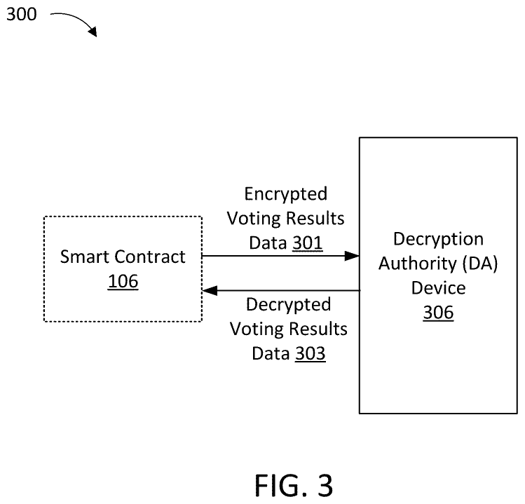

FIG. 3 illustrates a system 300 associated with a phase for aggregating encrypted votes submitted to a distributed ledger platform according to one or more embodiments of the present disclosure. In various embodiments, the system 300 illustrates aggregating encrypted votes after the voting period has ended. The system 300 can be a distributed ledger platform for electronic voting and/or electronic polling. In various embodiments, one or more portions of the system 300 corresponds to the system 100 and/or the system 200. The system 300 includes the smart contract 106 and/or a decryption authority (DA) device 306. In various embodiments, the smart contract 106 can be managed by and/or included in the distributed ledger system 108.

In various embodiments, after the voting period associated with the system 200 has ended, the smart contract 106 can aggregate all votes (e.g., all encrypted votes) based on the aggregation algorithm employed for aggregating votes to provide voting results data. In various embodiments, the voting results data provided by the aggregation algorithm can be a ciphertext representing the voting results. In various embodiments, the DA device 306 can access encrypted voting results data 301 (e.g., the ciphertext) in the smart contract 106 to perform decryption with respect to the encrypted voting results data 301. The DA device 306 can decrypt the encrypted voting results data 301 to generated decrypted voting results data 303. In various embodiments, the DA device 306 can decrypt the encrypted voting results data 301 via one or more threshold Paillier cryptosystem decryption techniques.

In various embodiments, since the distributed ledger of the distributed ledger system 108 is public and immutable, respective users can check the validity of the votes and/or that the votes were provided by eligible users by validating the zero-knowledge proofs stored on-chain by the distributed ledger. Moreover, in various embodiments, respective users can also verify the voting result data by aggregating the votes stored in the smart contract 106 using the aggregation algorithm and/or by instructing the DA device 306 to decrypt the aggregated votes. Therefore, public verifiability with respect to the aggregated votes can be provided. In some embodiments, multiple DA devices in the system 300 can be configured to decrypt the aggregated votes where respective DA devices comprise a portion of a secret decryption key required for decrypting the aggregated votes. For example, in certain embodiments, in addition to user registration illustrated in FIG. 1, a key generation process can be performed to generate one or more keys. For example, a key generation algorithm can generate a public key and multiple different shares of the decryption key. The public key can be published to all entities and each of the shares can be distributed to a respective DA device. Once successfully decrypted, the voting results can be transformed into a human-readable format and/or transmitted to the user device 102 to be displayed via an electronic interface of the user device 102. In various embodiments, the DA device 306 can decrypt the encrypted voting results to determine a number of user that select a certain option of a question.

### Exemplary Distributed Ledger Processes for Electronic Voting and/or Electronic Polling

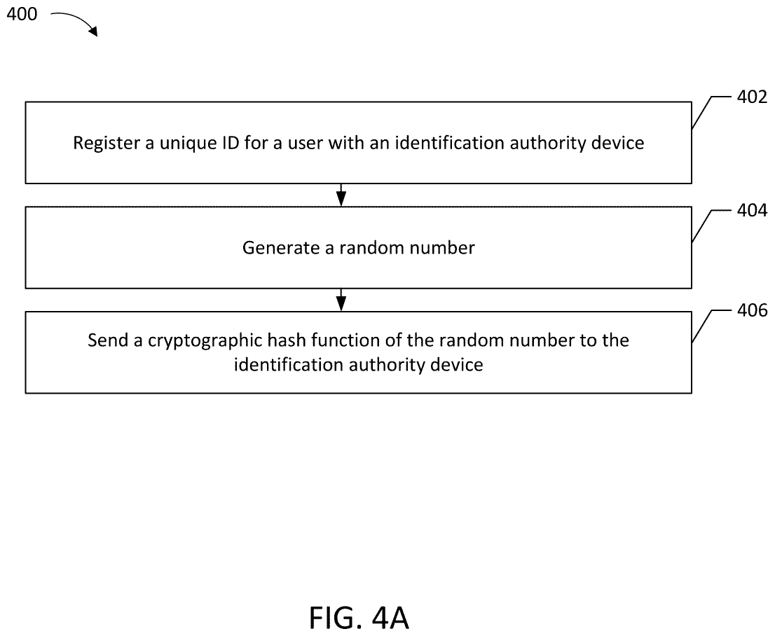

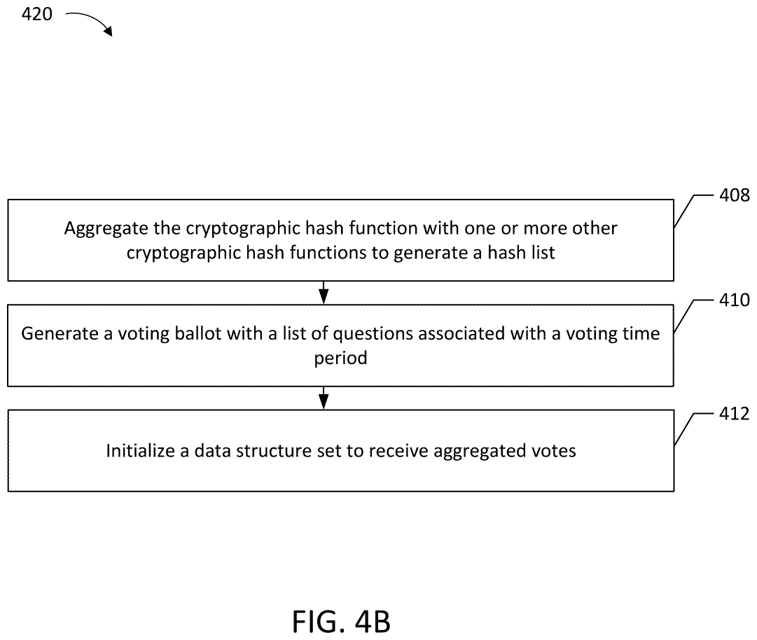

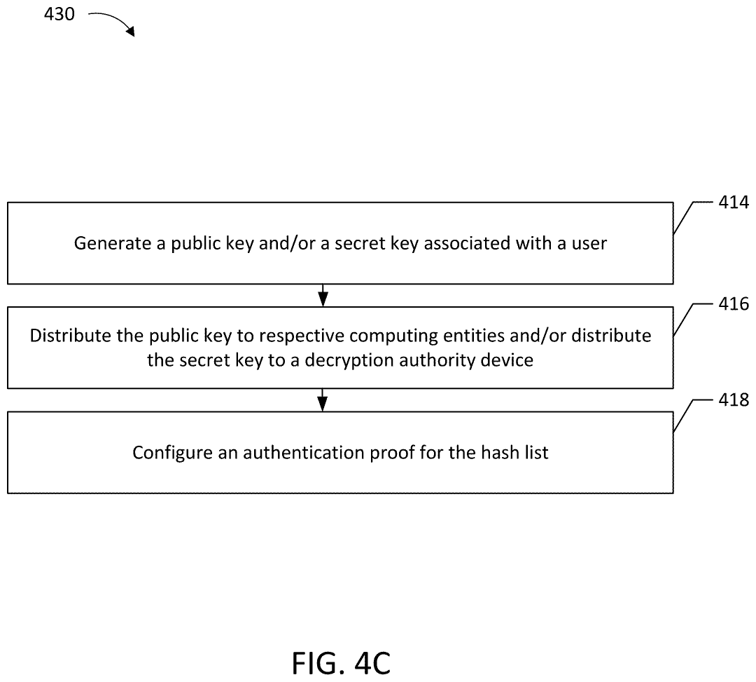

FIG. 4A illustrates a distributed ledger process 400 for initializing an electronic voting system based on distributed ledger technology according to one or more embodiments of the present disclosure. The distributed ledger process 400 can correspond to one or more processes performed by the system 100. In one or more embodiments, the distributed ledger process 400 can correspond to one or more processes performed by the user device 102.

The distributed ledger process 400 can include a step 402 that registers a unique ID for a user with an identification authority device. In various embodiments, a user Pᵢ (e.g., user device 102) registers for a unique ID with an identification authority (e.g., IA device 104). The distributed ledger process 400 can additionally or alternatively include a step 404 that generates a random number (e.g., a random l-bit number). The distributed ledger process 400 can additionally or alternatively include a step 406 that sends a cryptographic hash function of the random number to the identification authority device. For example, it should be noted that the identification authority device does not issue a unique ID for Pᵢ directly. Instead, the user Pᵢ generates a random number, xᵢ, which is kept secret by the user Pᵢ and gives a cryptographic hash function, hᵢ, of xᵢ to the identification authority device, where hᵢ=h(xᵢ). This ensures the privacy and anonymity of the user Pᵢ as the identification authority only knows hᵢ, and not xᵢ.

FIG. 4B illustrates a distributed ledger process 420 for initializing an electronic voting system based on distributed ledger technology according to one or more embodiments of the present disclosure. The distributed ledger process 420 can correspond to one or more processes performed by the system 100. In one or more embodiments, the distributed ledger process 420 can correspond to one or more processes performed by the smart contract 106.

The distributed ledger process 420 can include a step 408 that aggregates the cryptographic hash function with one or more other cryptographic hash functions to generate a hash list. In various embodiments, the identification authority creates, maintains, and publishes a list H of the cryptographic hash functions of the one or more user registered in a smart contract (e.g., the smart contract 106) of the exemplary voting system, where the smart contract is a public, self-executing, and/or self-enforcing program running on a distributed ledger platform (e.g., the distributed ledger system 108).

The distributed ledger process 420 can additionally or alternatively include a step 410 that generates a voting ballot with a list of questions associated with a voting time period. An exemplary voting ballot can comprise a list of questions Q that can be implemented on the smart contract and an associated voting time period T can be defined. In an exemplary embodiment of the present disclosure, one or more users can be permitted to submit respective votes within the timeframe established by the voting time period T. After the time period is established, an aggregation algorithm A can be implemented to aggregate the votes submitted by one or more users. The distributed ledger process 420 can additionally or alternatively include a step 412 that initializes a data structure set to receive aggregated votes. In some embodiments, a data structure set R is initialized to receive the aggregated votes.

FIG. 4C illustrates a distributed ledger process 430 for initializing an electronic voting system based on distributed ledger technology according to one or more embodiments of the present disclosure. The distributed ledger process 430 can correspond to one or more processes performed by the system 100. In one or more embodiments, the distributed ledger process 430 can correspond to one or more processes related to key generation.

The distributed ledger process 430 can include a step 414 that generates a public key and/or a secret key associated with a user. In various embodiments, a public key pk and/or secret key sk associated with a user Pᵢ can be generated. The distributed ledger process 430 can additionally or alternatively include a step 416 that distributes the public key to respective computing entities and/or distribute the secret key to a decryption authority device. In some embodiments, the secret key sk can be divided into multiple shares (sk₁, . . . , skₜ) in such a manner that when re-combined, the original value of sk can be restored. In such cases, the public key pk can be distributed to all entities in an exemplary remote electronic voting system based on distributed ledger technology comprising: a smart contract running on a blockchain platform, one or more users, one or more identification authorities, and/or one or more decryption authorities. Further, in certain embodiments, the aforementioned shares of the secret key sk can be distributed to multiple decryption authorities where the number of decryption authorities is equal to the number of divided shares of sk, thus ensuring that a single distributed authority does not have access to the entire secret key. The distributed ledger process 430 can additionally or alternatively include a step 418 that configures an authentication proof for the hash list. In some embodiments, a zero-knowledge proof authentication protocol can be employed for each user in H to generate a ZKP πᵢ^{auth}. In various embodiments, a user can employ the zero-knowledge proof authentication protocol to authenticate themselves to cast votes.

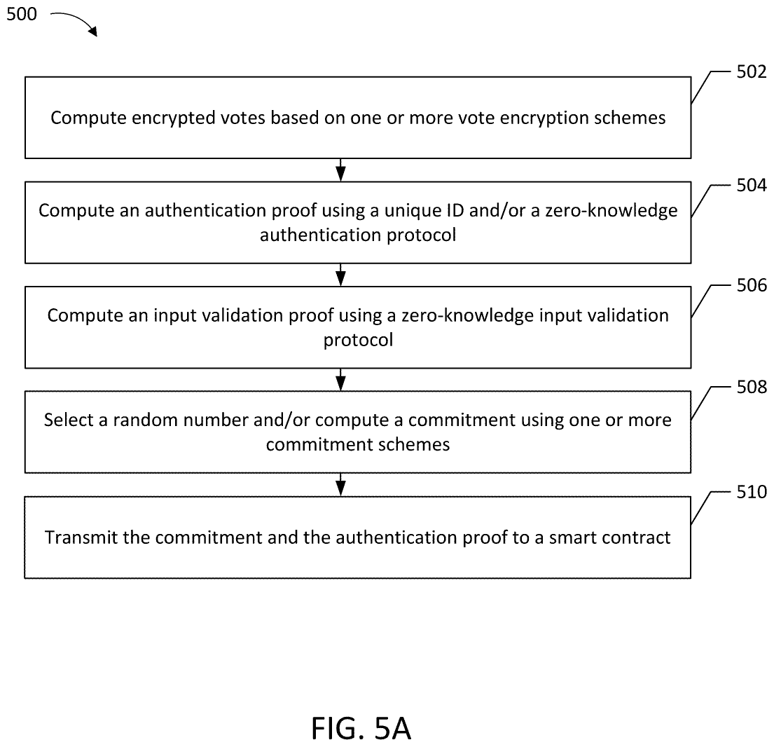

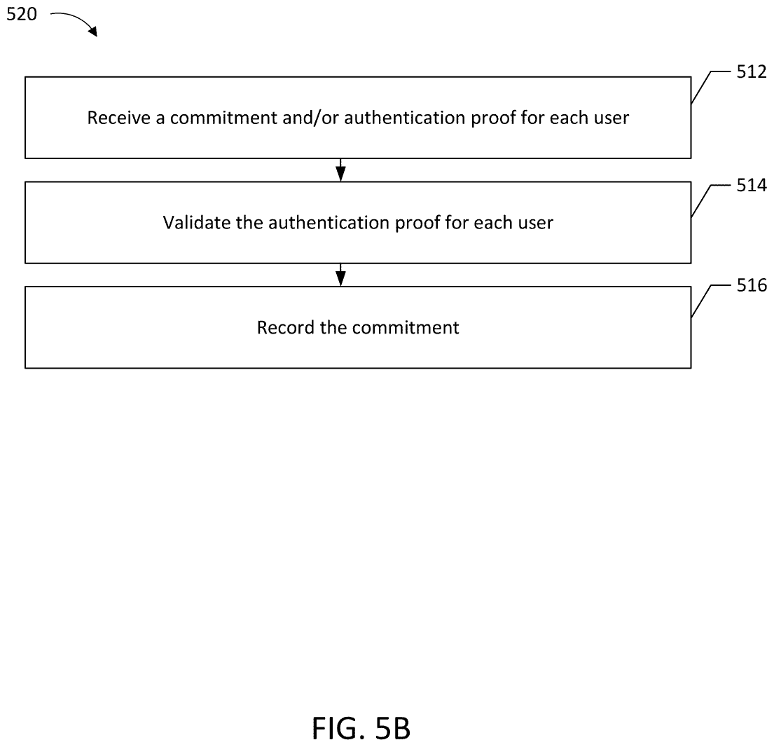

FIG. 5A illustrates a distributed ledger process 500 for submitting votes for an electronic voting system based on distributed ledger technology according to one or more embodiments of the present disclosure. The distributed ledger process 500 can correspond to one or more processes performed by the system 200. In one or more embodiments, the distributed ledger process 500 can correspond to one or more processes performed by the user device 102.

The distributed ledger process 500 can include a step 502 that computes encrypted votes based on one or more vote encryption schemes. In various embodiments, a user Pᵢ (e.g., user device 102) computes encrypted votes (e.g., encrypted votes 204) based on one or more vote encryption schemes. The distributed ledger process 500 can additionally or alternatively include a step 504 that computes an authentication proof using a unique ID and/or a zero-knowledge authentication protocol. For example, the user Pᵢ can compute an authentication proof πᵢ^{auth} (e.g., the authentication proof 206) using a unique ID xᵢ and providing a key of the zk-SNARK via one or more zero-knowledge authentication protocols. The distributed ledger process 500 can additionally or alternatively include a step 506 that computes an input validation proof using a zero-knowledge input validation protocol. For example, the user Pᵢ can additionally compute an input validation proof πᵢ^{inp} (e.g., the input validation proof 208) via one or more zero-knowledge input validation protocols. The distributed ledger process 500 can additionally or alternatively include a step 508 that selects a random number and/or computes a commitment using one or more commitment schemes. For example, the user Pᵢ can additionally select a random number rᵢ and/or compute a commitment cmᵢ=C(Rᵢ, rᵢ) using one or more commitment schemes. The distributed ledger process 500 can additionally or alternatively include a step 510 that transmits the commitment and the authentication proof to a smart contract. For example, in various embodiments, the user Pᵢ can transmit the commitment cmᵢ and the authentication proof πᵢ^{auth} to the smart contract SC (e.g., the smart contract 106).

FIG. 5B illustrates a distributed ledger process 520 for submitting votes for an electronic voting system based on distributed ledger technology according to one or more embodiments of the present disclosure. The distributed ledger process 520 can correspond to one or more processes performed by the system 200. In one or more embodiments, the distributed ledger process 520 can correspond to one or more processes performed by the smart contract 106.

The distributed ledger process 520 can include a step 512 that receives a commitment and/or a validation proof for each user. For example, the smart contract 106 receive validate the commitment cmᵢ and/or the authentication proof πᵢ^{auth}. The distributed ledger process 520 can additionally or alternatively include a step 514 that validates the authentication proof for each user. For example, the smart contract 106 can validate the authentication proof πᵢ^{auth}. The distributed ledger process 520 can additionally or alternatively include a step 516 that records the commitment. For example, the smart contract 106 can record the commitment cmᵢ in response to a valid authentication proof.

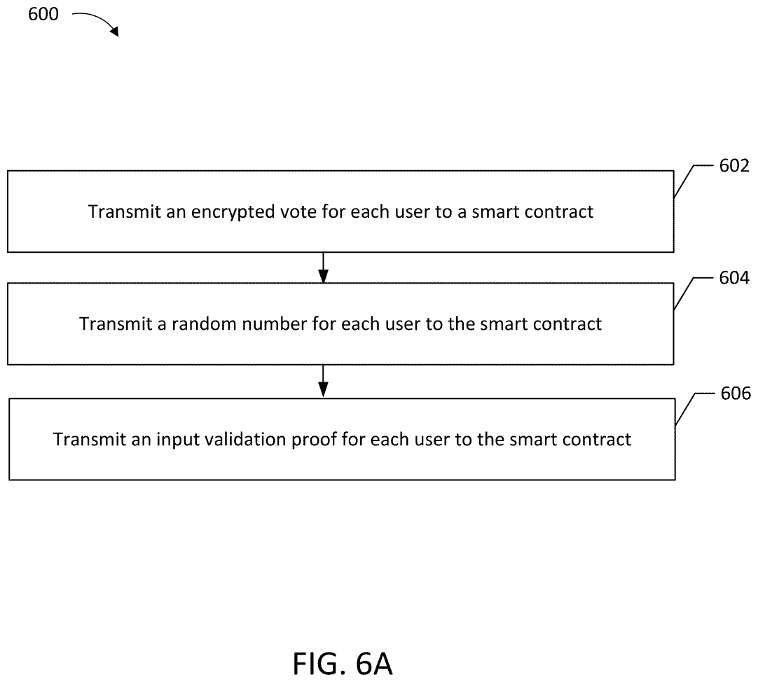

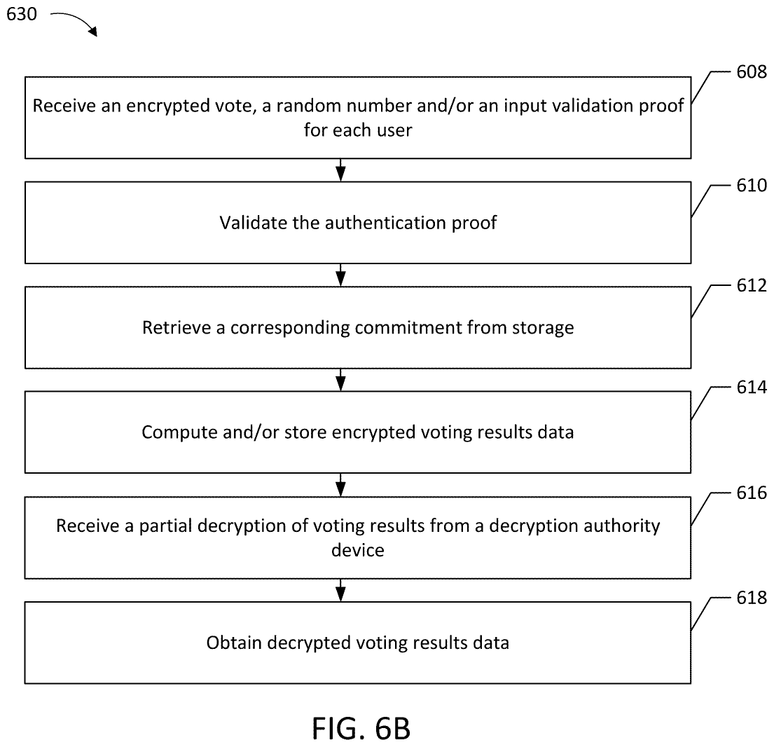

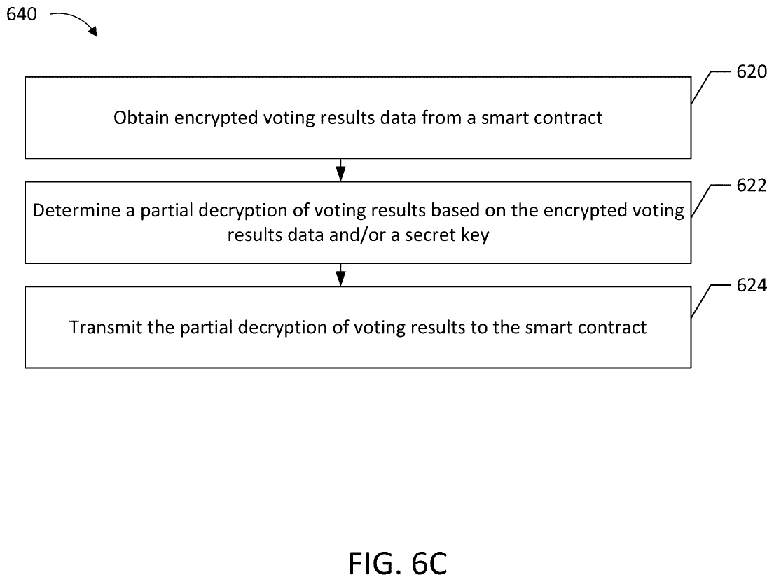

FIG. 6A illustrates a distributed ledger process 600 for aggregating votes for an electronic voting system based on distributed ledger technology according to one or more embodiments of the present disclosure. The distributed ledger process 600 can correspond to one or more processes performed by the system 300. In one or more embodiments, the distributed ledger process 600 can correspond to one or more processes performed by the user device 102.

The distributed ledger process 600 can include a step 602 that transmits an encrypted vote for each user to a smart contract. For example, the user device 102 can transmit encrypted vote Rᵢ to the smart contract 106. The distributed ledger process 600 can additionally or alternatively include a step 604 that transmits a random number for each user to the smart contract. For example, the user device 102 can transmit random number rᵢ to the smart contract 106. The distributed ledger process 600 can additionally or alternatively include a step 606 that transmits an input validation proof for each user to the smart contract. For example, the user device 102 can transmit input validation proof πᵢ^{inp} to the smart contract 106.

FIG. 6B illustrates a distributed ledger process 630 for aggregating votes for an electronic voting system based on distributed ledger technology according to one or more embodiments of the present disclosure. The distributed ledger process 630 can correspond to one or more processes performed by the system 300. In one or more embodiments, the distributed ledger process 630 can correspond to one or more processes performed by the smart contract 106.

The distributed ledger process 630 can include a step 608 that receives an encrypted vote, a random number and/or an input validation proof for each user. The distributed ledger process 630 can additionally or alternatively include a step 610 that validates the authentication proof. The distributed ledger process 630 can additionally or alternatively include a step 612 that retrieves a corresponding commitment from storage. In various embodiments, the smart contract can validate the input validation proof πᵢ^{inp} and, in response to validation of the input validation proof πᵢ^{inp}, the smart contract 106 can retrieve the commitment cmᵢ. In various embodiments, the smart contract can compare the commitment cmᵢ to an encrypted commitment to determine a vote R based on a predefined aggregation algorithm A. The distributed ledger process 630 can additionally or alternatively include a step 614 that computes and/or stores encrypted voting results data. The distributed ledger process 630 can additionally or alternatively include a step 616 that retrieves a partial decryption of voting results from a decryption authority device. The distributed ledger process 630 can additionally or alternatively include a step 618 that obtains decrypted voting results data. In various embodiments, the decryption authority device (e.g., the DA device 306) can decrypt voting results Si and can provide the voting results Si to the smart contract to obtain final voting results S.

FIG. 6C illustrates a distributed ledger process 640 for aggregating votes for an electronic voting system based on distributed ledger technology according to one or more embodiments of the present disclosure. The distributed ledger process 640 can correspond to one or more processes performed by the system 300. In one or more embodiments, the distributed ledger process 640 can correspond to one or more processes performed by the DA device 306.

The distributed ledger process 640 can include a step 620 that obtains encrypted voting results data from a smart contract. The distributed ledger process 640 can additionally or alternatively include a step 622 that determines a partial decryption of voting results based on the encrypted voting results data and/or a secret key. The distributed ledger process 640 can additionally or alternatively include a step 624 that transmits the partial decryption of voting results to the smart contract.

### Performance Results for Exemplary Distributed Ledger Systems

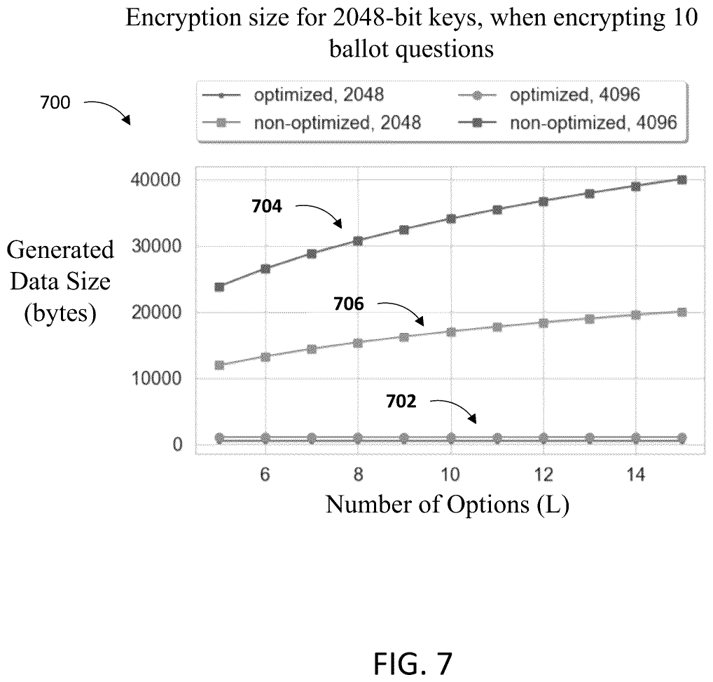

FIG. 7 illustrates a graph 700 related to encryption of a ballot question. The graph 700 includes data 702 related to a distributed ledger platform as disclosed herein, data 704 related to a non-optimized voting platform, and data 706 related to another non-optimized voting platform. As shown in FIG. 7, the amount of data generated by a distributed ledger platform (e.g., the distributed ledger system 108) as disclosed herein generates up to 97% less data than other non-optimized voting platforms, thereby significantly reducing a number of computing resources for an electronic voting system and/or an electronic polling system.

### Exemplary System Architecture

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

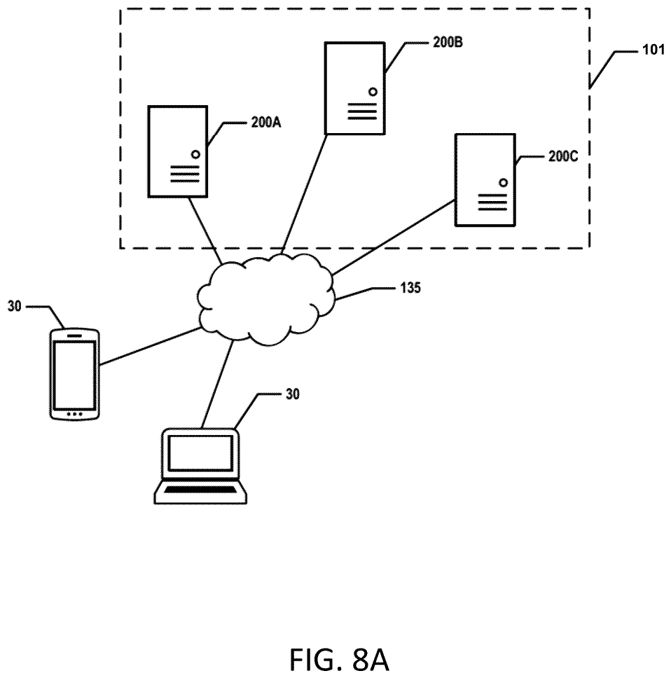

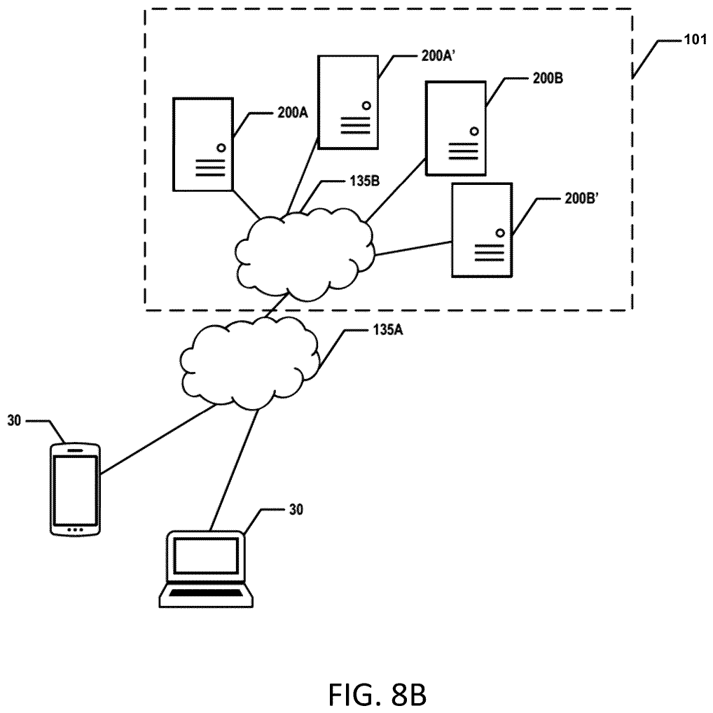

FIG. 8A provides an illustration of a system that can be used in conjunction with various embodiments of the present invention. As shown in FIG. 8A, the system may comprise a distributed platform 101 comprising two or more node computing entities 201 (e.g., 200A, 200B, 200C). As shown in FIG. 8A, the system may further comprise one or more non-node computing entities 30, one or more networks 135, and/or the like. FIG. 8B provides an illustration of another system that can be used in conjunction with various embodiments of the present invention. As shown in FIG. 8B, the system may comprise a distributed platform 101 comprising two or more node computing entities 201 (e.g., 200A, 200B), 200′ (e.g., 200A′, 200B′), one or more external networks 135A, and/or one or more internal networks 135B. For example, in an example embodiment, the distributed platform 101 comprises a plurality of node computing entities 201, 200′ in communication with one another via a network 135B. The network 135B may be an internal or private network. As shown in FIG. 8B, the system may further comprise one or more non-node computing entities 30, one or more other and/or external networks 135A, and/or the like. For example, the other and/or external network 135A may be external, public, and/or a different network from the internal and/or private network 135B. Each of the components of the system may be in electronic communication with, for example, one another over the same or different wireless or wired networks 135 including, for example, a wired or wireless Personal Area Network (PAN), Local Area Network (LAN), Metropolitan Area Network (MAN), Wide Area Network (WAN), or the like. Additionally, while FIGS. 8A and/or 8B illustrate certain system entities as separate, standalone entities, the various embodiments are not limited to this particular architecture. In one or more embodiments, at least a portion of the distributed ledger system 108 can correspond to at least a portion of the distributed platform 101 illustrated in FIG. 8A and/or FIG. 8B.

### Exemplary Node Computing Entity

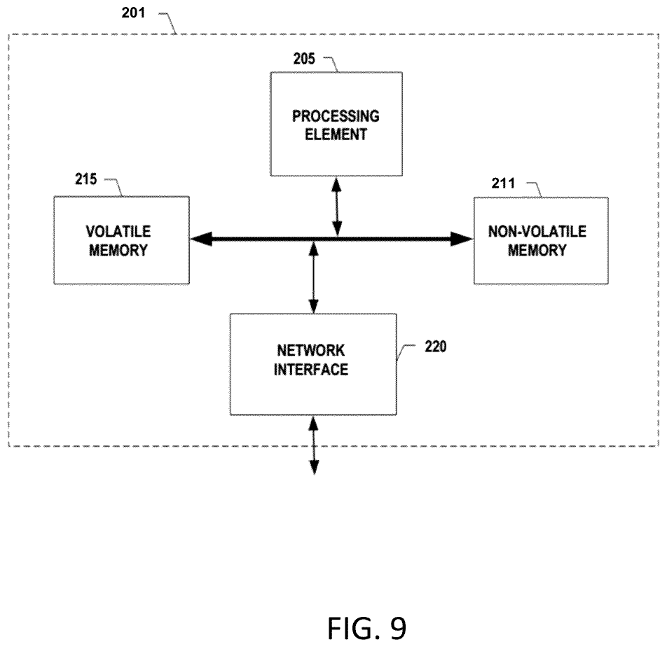

FIG. 9 provides a schematic of a node computing entity 201 (e.g., 200A, 200B, 200C) according to one embodiment of the present invention. A node is an individual entity within a distributed ledger system, and can further described as a full node (e.g., stores the entire blockchain), a mining node (e.g., full node that also maintains the blockchain by publishing new blocks), a lightweight node (e.g., node that does not maintain a history of the entire blockchain), and/or the like. In general, the terms node computing entity, computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the node computing entity 201 may also include one or more network and/or communications interfaces 220 for communicating with various computing entities, such as by communicating data, content, information, and/or similar terms used herein interchangeably that can be transmitted, received, operated on, processed, displayed, stored, and/or the like. For instance, the node computing entity 201 may communicate with other node computing entities 201, 200′, one or more non-node computing entities 30, and/or the like.

As shown in FIG. 9, in one embodiment, the node computing entity 201 may include or be in communication with one or more processing elements 205 (also referred to as processors, processing circuitry, and/or similar terms used herein interchangeably) that communicate with other elements within the node computing entity 201 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the node computing entity 201 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 211 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the node computing entity 201 may further include or be in communication with volatile media (also referred to as volatile storage, memory, memory storage, memory circuitry and/or similar terms used herein interchangeably). In one embodiment, the volatile storage or memory may also include one or more volatile storage or memory media 315 as described above, such as RAM, DRAM, SRAM, FPM DRAM, EDO DRAM, S DRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 205. Thus, the databases, database instances, database management system entities, data, applications, programs, program modules, scripts, source code, object code, byte code, compiled code, interpreted code, machine code, executable instructions, and/or the like may be used to control certain aspects of the operation of the node computing entity 201 with the assistance of the processing element 205 and operating system.

As indicated, in one embodiment, the node computing entity 201 may also include one or more network and/or communications interfaces 220 for communicating with various computing entities, such as by communicating data, content, information, and/or similar terms used herein interchangeably that can be transmitted, received, operated on, processed, displayed, stored, and/or the like. For instance, the node computing entity 201 may communicate with computing entities or communication interfaces of other node computing entities 201, 200′, and/or the like.

As indicated, in one embodiment, the node computing entity 201 may also include one or more network and/or communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the node computing entity 201 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The node computing entity 201 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), Hypertext Markup Language (HTML), and/or the like.

As will be appreciated, one or more of the node computing entity's 200 components may be located remotely from other node computing entity 201 components, such as in a distributed system. Furthermore, one or more of the components may be combined and additional components performing functions described herein may be included in the node computing entity 201. Thus, the node computing entity 201 can be adapted to accommodate a variety of needs and circumstances.

In example embodiments, the node computing entity 201 may be in communication with one or more other node computing entities 201, 200′ and/or one or more non-node computing entities 30. In example embodiments, the node computing entity 201 may be in communication with one or more other node computing entities 201, 200′ configured for providing events, consensus requests, and/or the like; performing consensus processing; storing a copy of a distributed ledger; and/or the like.

### Another Exemplary Node Computing Entity

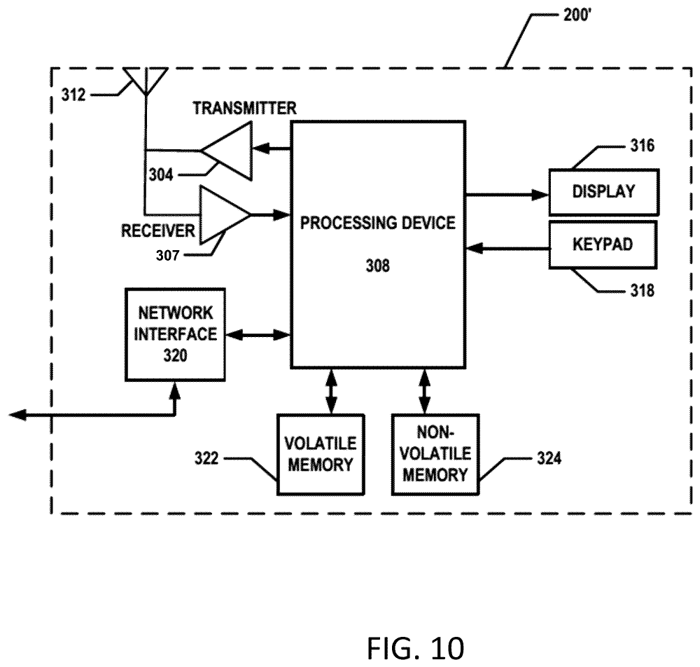

FIG. 10 provides an illustrative schematic representative of another node computing entity 201′ that can be used in conjunction with embodiments of the present invention. As shown in FIG. 10, a node computing entity 201′ can include an antenna 312, a transmitter 304 (e.g., radio), a receiver 307 (e.g., radio), and a processing element 308 that provides signals to and receives signals from the transmitter 304 and receiver 307, respectively. The signals provided to and received from the transmitter 304 and the receiver 307, respectively, may include signaling information/data in accordance with an air interface standard of applicable wireless systems to communicate with various entities, such as another node computing entity 201, 200′, one or more non-node computing entities 30, and/or the like. In this regard, the node computing entity 201′ may be capable of operating with one or more air interface standards, communication protocols, modulation types, and access types. More particularly, the node computing entity 201′ may operate in accordance with any of a number of wireless communication standards and protocols. In a particular embodiment, the node computing device 200′ may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the node computing entity 201′ can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The node computing entity 201′ can also download changes, add-ons, and updates, for instance, to its firmware, software (e.g., including executable instructions, applications, program modules), and operating system.

According to one embodiment, the node computing entity 201′ may include location determining aspects, devices, modules, functionalities, and/or similar words used herein interchangeably. For example, the node computing entity 201′ may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the computing entity's 200′ position in connection with a variety of other systems, including cellular towers, Wi-Fi access points, and/or the like. Similarly, the node computing entity 201′ may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The node computing entity 201′ may also comprise a user interface device comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via the node computing entity 201′ to cause display or audible presentation of information/data and for user interaction therewith via one or more user input interfaces. The user input interface can comprise any of a number of devices allowing the node computing entity 201′ to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the node computing entity 201′ and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the node computing entity 201′ can collect information/data, user interaction/input, and/or the like.

The node computing entity 201′ can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the node computing entity 201′.

In example embodiments, the node computing entity 201 may be in communication with one or more other node computing entities 201, 200′ and/or one or more non-node computing entities 30. In example embodiments, the node computing entity 201 may be in communication with one or more other node computing entities 201, 200′ configured for providing events, consensus requests, and/or the like; performing consensus processing; storing a copy of a distributed ledger; and/or the like.

In an example embodiment, a non-node computing entity 30 may be a computing entity configured for user interaction (e.g., via one or more user interface devices thereof) for receiving, generating, and/or providing events and/or information related thereto and/or communicating with node computing entities 201, 200′. In various embodiments, a user may be a person interacting with a non-node computing entity 30 (e.g., via the user interface devices thereof) or a machine user (e.g., an application, service, and/or the like operating on the non-node computing entity 30). In various embodiments, the non-node computing entity 30 may be a computing entity external to the distributed ledger.

In an example embodiment, a non-node computing entity 30 may be in communication with one or more node computing entities 201, 200′ via one or more wired or wireless networks 135. In one embodiment, the non-node computing entity 30 may include one or more components that are functionally similar to those of node computing entities 201, 200′. For example, in one embodiment, a non-node computing entity 30 may include: (1) a processing element that communicates with other elements via a system interface or bus; (2) one or more user interface devices (e.g., display, touchscreen display, hard or soft keyboard, mouse, and/or the like); (3) transitory and non-transitory memory; and (4) a network and/or communications interface configured to communicate via one or more wired or wireless networks 135. For example, the non-node computing entity 30 may receive user input (e.g., via the user input interface thereof) and provide (e.g. transmit) an indication of the user input to one or more node computing entities 201, 200′ (e.g., via the network and/or communications interface).

In one embodiment, any two or more of the illustrative components of the architecture of FIGS. 1A and/or 1B may be configured to communicate with one another via respective communicative couplings to one or more networks 135. The networks 135 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 135 may have any suitable communication range associated therewith and may include, for example, global networks (e.g., the Internet), MANs, WANs, LANs, or PANs. In addition, the networks 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### Exemplary Methods for Executing Electronic Voting in a Distributed Ledger System

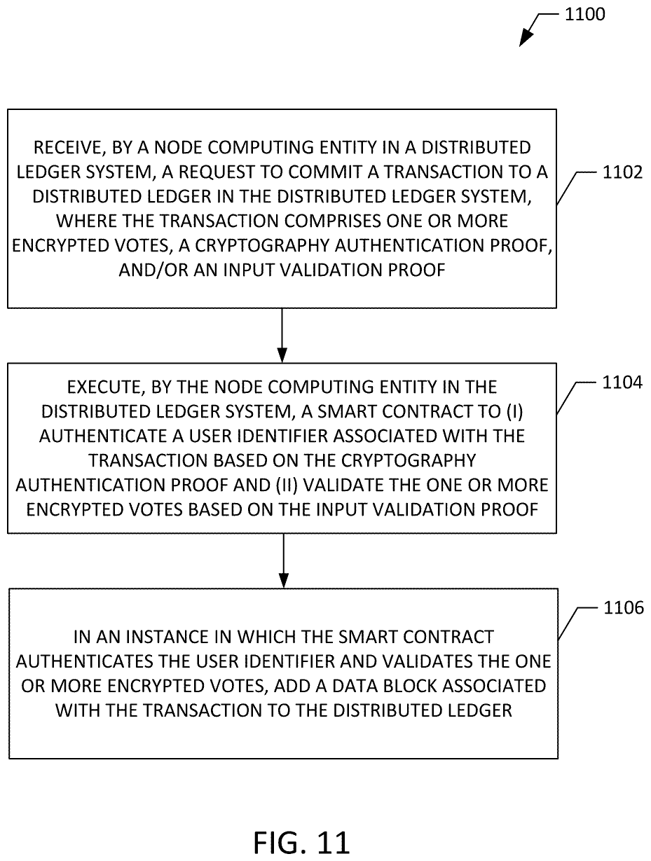

FIG. 11 illustrates a flowchart depicting methods according to example embodiments of the present disclosure. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present disclosure and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems that perform the specified functions, or combinations of special purpose hardware and computer instructions.

FIG. 11 illustrates a flowchart of a method 1100 for execution in a distributed ledger system according to one or more embodiments of the present disclosure. According to the illustrated embodiment, at 1102, a request to commit a transaction to a distributed ledger in the distributed ledger system is received by a node computing entity in the distributed ledger system, where the transaction comprises one or more encrypted votes, a cryptography authentication proof, and/or an input validation proof. The cryptography authentication proof can be, for example, a zero-knowledge authentication proof. Additionally, at 1104, a smart contract is executed, by the node computing entity in the distributed ledger system, to (i) authenticate a user identifier associated with the transaction based on the cryptography authentication proof and (ii) validate the one or more encrypted votes based on the input validation proof. Additionally, at 1106, a data block associated with the transaction is added to the distributed ledger in an instance in which the smart contract authenticates the user identifier and validates the one or more encrypted votes.

In certain embodiments, receiving the request to commit the transaction to the distributed ledger comprises receiving the request to commit the transaction to the distributed ledger within a voting period for an electronic voting process. In certain embodiments, the method 1100 further includes defining, by the node computing entity in the distributed ledger system, a voting ballot comprising one or more ballot questions via the smart contract. In certain embodiments, the method 1100 further includes transmitting, by the node computing entity in the distributed ledger system, the voting ballot to a user device associated with the user identifier.

In certain embodiments, the one or more encrypted votes are encrypted via homomorphic encryption. In certain embodiments, the input validation proof is a non-interactive zero-knowledge proof protocol that prevents the user identifier from submitting one or more invalid votes. In certain embodiments, the cryptography authentication proof is a non-interactive zero-knowledge proof protocol employed to authenticate the user identifier while providing privacy and anonymity for the user identifier. In certain embodiments, the cryptography authentication proof employs one or more hashing functions associated with the user identifier.

In an example embodiment, an apparatus for performing the method 1100 of FIG. 11 above may include a processor configured to perform some or each of the operations (1102, 1104 and/or 1106) described above. The processor may, for example, be configured to perform the operations (1102, 1104 and/or 1106) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 1102, 1104 and/or 1106 may comprise, for example, the processor and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for execution in a distributed ledger system, comprising:
receiving, by a node computing entity in the distributed ledger system, a request to commit a transaction to a distributed ledger in the distributed ledger system, wherein the transaction comprises one or more encrypted votes, a cryptography authentication proof, and an input validation proof;
executing, by the node computing entity in the distributed ledger system, a smart contract to (i) authenticate a user identifier associated with the transaction based on the cryptography authentication proof and (ii) validate the one or more encrypted votes based on the input validation proof; and
in an instance in which the smart contract authenticates the user identifier and validates the one or more encrypted votes, adding a data block associated with the transaction to the distributed ledger.

2. The method of claim 1, further comprising:
defining, by the node computing entity in the distributed ledger system, a voting ballot comprising one or more ballot questions via the smart contract; and
transmitting, by the node computing entity in the distributed ledger system, the voting ballot to a user device associated with the user identifier.

3. The method of claim 1, wherein the one or more encrypted votes are encrypted via homomorphic encryption.

4. The method of claim 1, wherein the input validation proof is a non-interactive zero-knowledge proof protocol that prevents the user identifier from submitting one or more invalid votes.

5. The method of claim 1, wherein the cryptography authentication proof is a zero-knowledge authentication proof.

6. The method of claim 1, wherein the cryptography authentication proof is a non-interactive zero-knowledge proof protocol employed to authenticate the user identifier while providing privacy and anonymity for the user identifier.

7. The method of claim 1, wherein the cryptography authentication proof employs one or more hashing functions associated with the user identifier.

8. The method of claim 1, wherein the receiving the request to commit the transaction to the distributed ledger comprises receiving the request to commit the transaction to the distributed ledger within a voting period for an electronic voting process.

9. An apparatus comprising at least one processor and at least one memory including program code, the at least one memory and the program code configured to, with the at least one processor, cause the apparatus to at least:
receive, by a node computing entity in a distributed ledger system, a request to commit a transaction to a distributed ledger in the distributed ledger system, wherein the transaction comprises one or more encrypted votes, a cryptography authentication proof, and an input validation proof;
execute, by the node computing entity in the distributed ledger system, a smart contract to (i) authenticate a user identifier associated with the transaction based on the cryptography authentication proof and (ii) validate the one or more encrypted votes based on the input validation proof; and
in an instance in which the smart contract authenticates the user identifier and validates the one or more encrypted votes, add a data block associated with the transaction to the distributed ledger.

10. The apparatus of claim 9, wherein the at least one memory and the program code are configured to, with the at least one processor, further cause the apparatus to at least:
define, by the node computing entity in the distributed ledger system, a voting ballot comprising one or more ballot questions via the smart contract; and
transmit, by the node computing entity in the distributed ledger system, the voting ballot to a user device associated with the user identifier.

11. The apparatus of claim 9, wherein the one or more encrypted votes are encrypted via homomorphic encryption.

12. The apparatus of claim 9, wherein the input validation proof is a non-interactive zero-knowledge proof protocol that prevents the user identifier from submitting one or more invalid votes.

13. The apparatus of claim 9, wherein the cryptography authentication proof is a zero-knowledge authentication proof.

14. The apparatus of claim 9, wherein the cryptography authentication proof is a non-interactive zero-knowledge proof protocol employed to authenticate the user identifier while providing privacy and anonymity for the user identifier.

15. The apparatus of claim 9, wherein the cryptography authentication proof employs one or more hashing functions associated with the user identifier.

16. The apparatus of claim 9, wherein the at least one memory and the program code are configured to, with the at least one processor, further cause the apparatus to at least:
receive the request to commit the transaction to the distributed ledger within a voting period for an electronic voting process.

17. A non-transitory computer storage medium comprising instructions, the instructions being configured to cause one or more processors to at least perform operations configured to:
receive, by a node computing entity in a distributed ledger system, a request to commit a transaction to a distributed ledger in the distributed ledger system, wherein the transaction comprises one or more encrypted votes, a cryptography authentication proof, and an input validation proof;
execute, by the node computing entity in the distributed ledger system, a smart contract to (i) authenticate a user identifier associated with the transaction based on the cryptography authentication proof and (ii) validate the one or more encrypted votes based on the input validation proof; and
in an instance in which the smart contract authenticates the user identifier and validates the one or more encrypted votes, add a data block associated with the transaction to the distributed ledger.

18. The non-transitory computer storage medium of claim 17, wherein the operations are further configured to:
define, by the node computing entity in the distributed ledger system, a voting ballot comprising one or more ballot questions via the smart contract; and
transmit, by the node computing entity in the distributed ledger system, the voting ballot to a user device associated with the user identifier.

19. The non-transitory computer storage medium of claim 17, wherein the one or more encrypted votes are encrypted via homomorphic encryption.

20. The non-transitory computer storage medium of claim 17, wherein the cryptography authentication proof is a zero-knowledge authentication proof.
